(19) United States
(12) Patent Application Publication
(10) Pub. No.: US 2015/0091937 A1
(43) Pub. Date: Apr. 2, 2015

(54) Method, System and Program for Selecting Colors Using a Biorhythm

(71) Applicant: Dianne Morgan, Mountainside, NJ (US)

(72) Inventor: Dianne Morgan, Mountainside, NJ (US)

(21) Appl. No.: 14/043,812

(22) Filed: Oct. 1, 2013

(51) Int. Cl. G06T 11/00; G06T 11/20

(52) U.S. Cl. CPC G06T 11/001; G06T 11/206
USPC 345/593

(57) ABSTRACT

A method, system and program product comprises obtaining a birth date for a user. A number of days from the birth date to a selected date is determined. A number of days into a first cycle is determined and a pair of colors is selected when the number is into a portion of the cycle. A number of days into a second cycle is determined and a pair of colors is selected when the number is into a portion of the cycle. A number of days into a third cycle is determined and a pair of colors is selected when the number is into a portion of the cycle. A number of days into a fourth cycle is determined and a pair of colors is selected when the number is into a portion of the cycle. The selected colors are displayed to the user.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to information systems. More particularly, one or more embodiments of the invention relate to color information systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Determining the appropriate color of clothing to wear can require a significant amount of time to perform.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an example presentation for the exemplary color system, in accordance with an embodiment of the present invention;

FIG. 2A is an example color presentation for the exemplary color system, in accordance with an embodiment of the present invention;

FIG. 2B is an example color presentation for the exemplary color system, in accordance with an alternative embodiment of the present invention;

FIG. 3 is an example color system, in accordance with an alternative embodiment of the present invention;

FIG. 4 is an example color system, in accordance with an alternative embodiment of the present invention;

FIGS. 5A-B illustrate an example color system, in accordance with an alternative embodiment of the present invention;

FIG. 6 is an example color system, in accordance with an alternative embodiment of the present invention;

FIG. 7 is an example color system, in accordance with an alternative embodiment of the present invention;

FIG. 8 illustrates an example method for the color system as described with reference to FIGS. 1-7, in accordance with an embodiment of the present invention;

FIG. 9 illustrates a block diagram depicting a conventional client/server communication system; and

FIG. 10 illustrates a typical computer system that, when appropriately configured or designed, may serve as a computer system 1000 for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention. Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units. A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc. Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein. In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products. An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A color system will be described which provides means and methods for selecting appropriate colors and not selecting appropriate colors. Color system uses biorhythm information in order to extract certain information. The extracted information is combined with an algorithm for producing a presentation of colors representing selected colors and not selected colors. As a non-limiting example, color system may be used for selecting the appropriate color of clothes to wear based upon a certain day. Non-limiting examples of applications for color system include clothes, makeup and signs.

The color system performs color selection based upon four different cycles with respective cycles of 23, 28, 33 and 38 days. As a non-limiting example, the biorhythm cycles may be thought of as inverted sinusoidal type cycles. In the second half, or upper portion of the cycles colors may be selected.

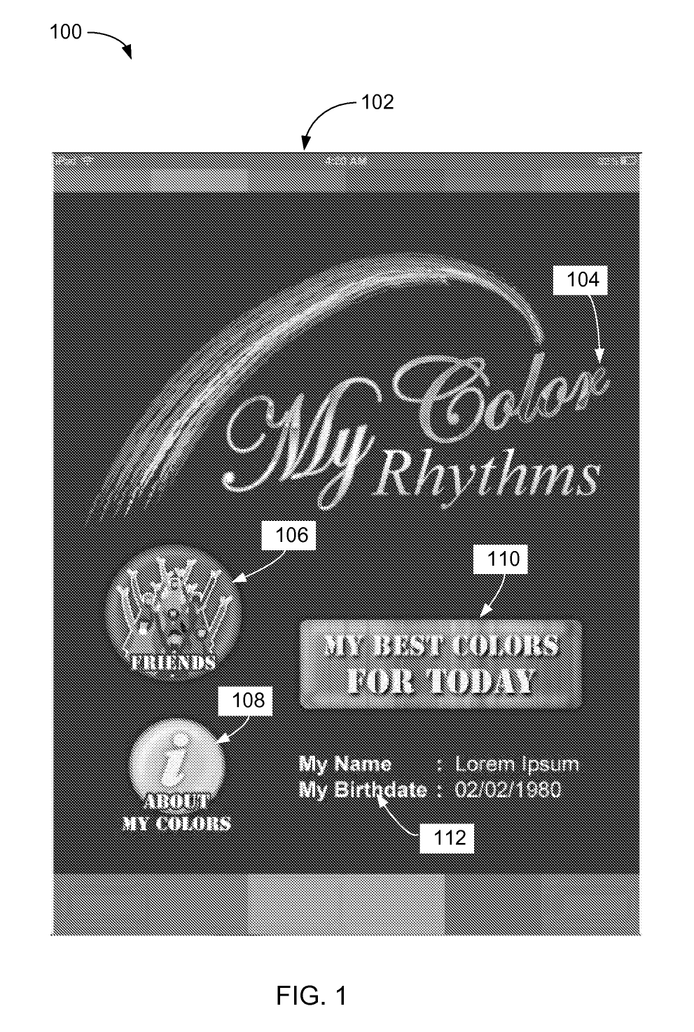

The color system will now be described in detail with reference to FIGS. 1-10.

FIG. 1 is an example presentation for the exemplary color system, in accordance with an embodiment of the present invention.

A presentation 100 presents information associated with the color system. Non-limiting examples of mechanisms for executing presentation of information include software, firmware, website and application. Furthermore, non-limiting examples of device presenting presentation 100 include computers, personal computers, desktop computers, laptop computers, tabular computing devices and smartphones.

Presentation 100 includes a presentation area 102. Presentation area 102 presents information associated with the color system. Presentation area 102 includes a branding portion 104, a friends selection 106, an about selection 108, a best colors selection 110 and an information portion 112.

Branding portion 104 presents branding information. Friends selection 106 enables presentation of friend-related information following selection. Non-limiting example of friend-related information presented include information associated with friends, acquaintances, coworkers and family. About selection 108 enables presentation of information about the color system following selection. Best colors selection 110 enables presentation of color information following selection. Information portion 112 presents information associated with user. Non-limiting examples of information presented via information portion 112 include name and birthdates.

FIG. 1 is an example presentation for the exemplary color system where branding information and user associated information is presented and selections for friends, about and best colors are provided.

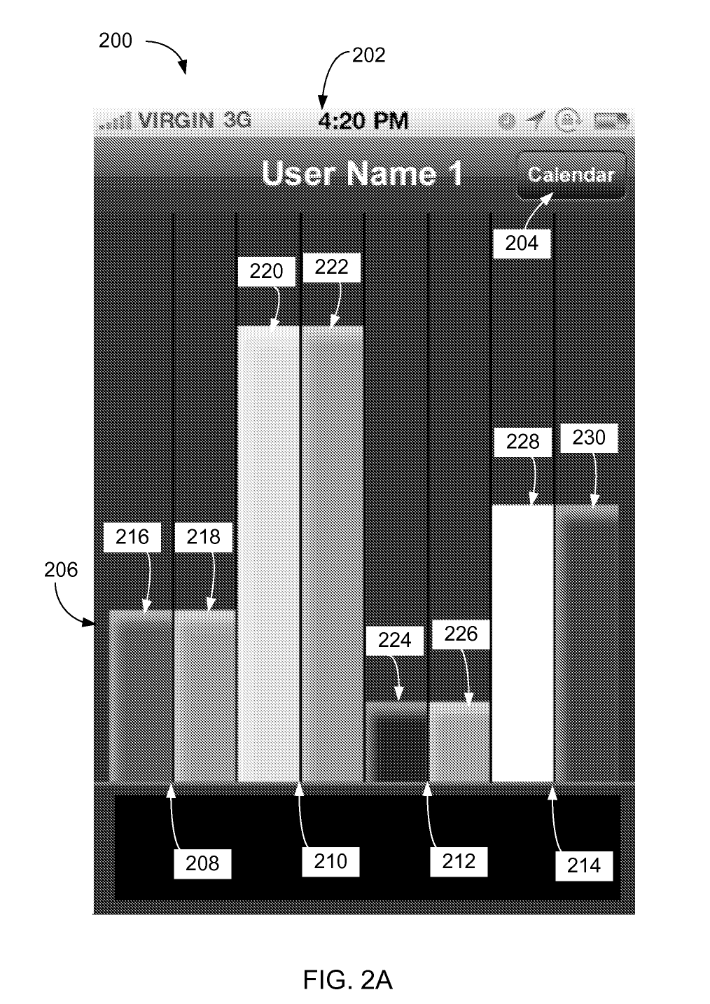

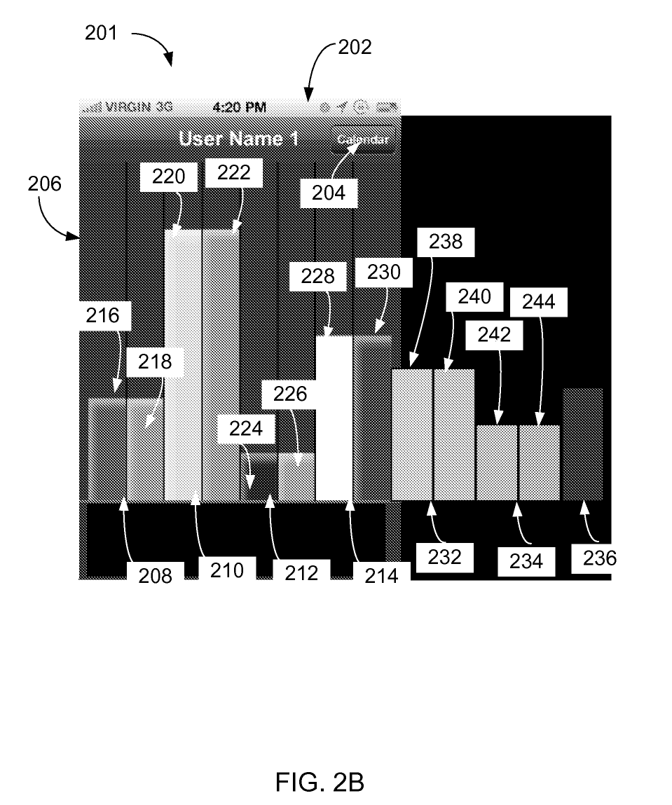

FIG. 2A is an example color presentation for the exemplary color system, in accordance with an embodiment of the present invention.

A color presentation 200 includes an information portion 202, a calendar selection 204 and a color chart 206.

Color presentation 200 presents information associated with the color system. Information portion 202 presents identifying and status information. Non-limiting examples of information presented via information portion 202 include service provider, time and user name. Calendar selection 204 enables presentation of calendar information following selection. Color chart 206 presents color information.

Color chart 206 includes a color portion 208, a color portion 210, a color portion 212 and a color portion 214.

Color portion 208 presents information associated with the colors red and orange. Color portion 210 presents information associated with colors yellow and green. Color portion 212 presents information associated with colors blue and light blue. Color portion 214 presents information associated with colors white and violet.

Color portion 208 includes a red color bar 216 and an orange color bar 218. Color portion 210 includes a yellow color bar 220 and a green color bar 222. Color portion 212 includes a blue color bar 224 and a light blue color bar 226. Color portion 214 includes a white color bar 228 and a violet color bar 230.

Red color bar 216 presents information associated with the color red. Orange color bar 218 presents information associated with the color orange. Yellow color bar 220 presents information associated with yellow. Green color bar 222 presents information associated with the color green. Blue color bar 224 presents information associated with color blue. Light blue color bar 226 presents information associated with the color light blue. White color bar 228 presents information associated with the color white. Violet color bar 230 presents information associated with the color violet.

Color chart 206 presents information associated with a selected color. As a non-limiting example, color chart 206 may present the colors yellow and green as selected as illustrated by yellow color bar 220 and green color bar 222, respectively, being the largest bars in size as shown. As another non-limiting example, color chart 206 may present the colors of blue and light blue as not being selected as illustrated by blue color bar 224 and light blue color bar 226, respectively, being the smallest bars in size as shown.

There are four major cycles that determine selected and not selected colors as presented by color portions 208, 210, 212 and 214. Color portion 208 is based on a 23 day cycle. Color portion 210 is based on a 28 day cycle. Color portion 212 is based on a 33 day cycle. And color portion 214 is based on a 38 day cycle.

The non-selected colors are represented by the first half of the respective cycles and the selected colors are represented in the second half of the respective cycles. As a non-limiting example, the colors red and orange are not selected on days 1 through 11.5 and are selected on days 11.5 through day 23. As a non-limiting example, the colors yellow and green are not selected on days 1 through 13 and are selected on days 14 through 28. As a non-limiting example, the colors blue and light blue are not selected on days 1 through 16.5 and are selected on days 16.5 through 33. As a non-limiting example, the colors violet and white are not selected on days 1 through 18 and are selected on days 19 through 38.

FIG. 2A is an example color presentation for the exemplary color system where various colors have selected times and not selected times.

FIG. 2B is an example color presentation for the exemplary color system, in accordance with an alternative embodiment of the present invention.

A color presentation 201 includes elements of color presentation 200 as described with reference FIG. 2A in addition to including a color portion 232, a color portion 234 and a magenta color bar 236.

Color portion 232 is represented based upon color portion 208 red and orange bars and white color bar 228 producing pink and peach color bars. Color portion 234 turquoise and teal is represented based upon green color bar 222 and color portion 212. Magenta color bar 236 is represented based upon violet color bar 230 and red color bar 216.

Color portion 232 includes a pink color bar 238 and a peach color bar 240. Color portion 234 includes a turquoise color bar 242 and a teal color bar 244.

Pink color bar 238 represents information associated with the color pink. Peach color bar 240 represents information associated with the color peach. Turquoise color bar 242 represents information associated with the color turquoise. Teal color bar 244 represents information associated with the color teal. Magenta color bar 236 represents information associated with the color magenta.

As a non-limiting example, pink color bar 238 may represent the average of red color bar 216 and white color bar 228. As a non-limiting example, peach color bar 240 may represent the average of orange color bar 218 and white color bar 228. As a non-limiting example, turquoise color bar 242 may represent the average of light blue color bar 226 and green color bar 222. As a non-limiting example, teal color bar 244 may represent the average of blue color bar 224 and green color bar 222.

FIG. 2B is an example color presentation for the exemplary color system where selected combinations of colors presented in FIG. 2A are combined to generate additional selected colors.

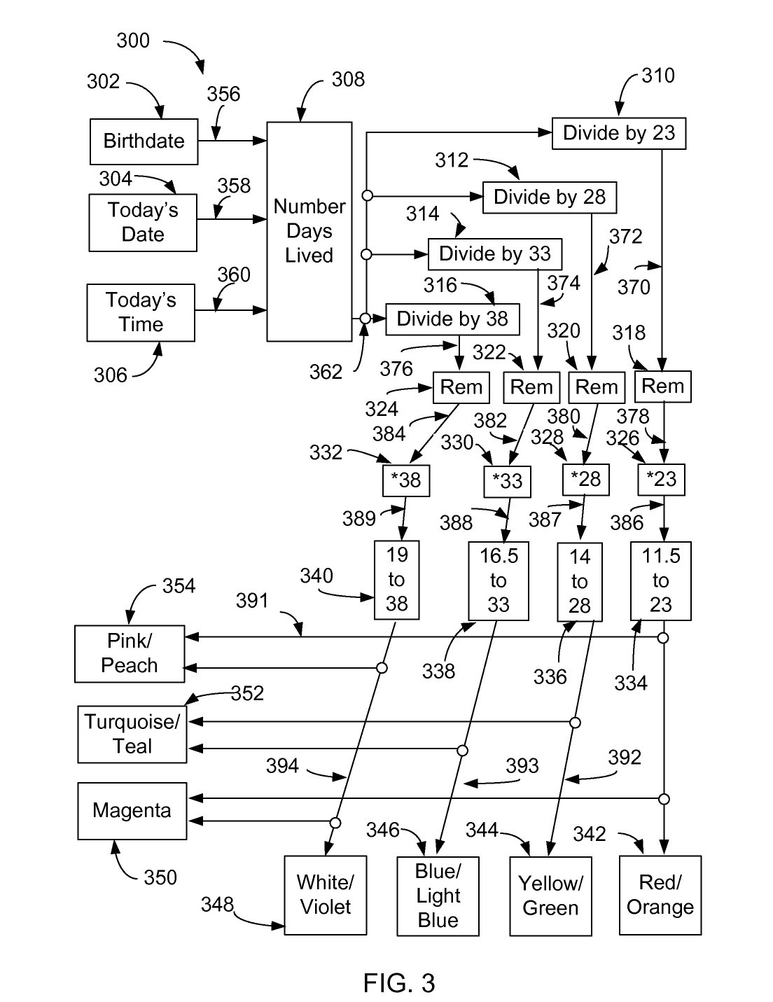

FIG. 3 is an example color system, in accordance with an alternative embodiment of the present invention.

A color system 300 includes a birth date portion 302, a current date portion 304, a current time portion 306, a number days lived portion 308, a divide by 23 portion 310, a divide by 28 portion 312, a divide by 33 portion 314, a divide by 38 portion 316, a remainder portion 318, a remainder portion 320, a remainder portion 322, a remainder portion 324, a multiply by 23 portion 326, a multiply by 28 portion 328, a multiply by 33 portion 330, a multiply by 38 portion 332, a first date selection portion 334, a second date selection portion 336, a third date selection portion 338, a fourth date selection portion 340, a red/orange portion 342, a yellow/green portion 344, a blue/light blue portion 346, a white/violet portion 348, a magenta portion 350, a turquoise/teal portion 352 and a pink/peach portion 354.

Number days lived portion 308 receives information from birth date portion 302 via a communication channel 356 from current date portion 304 via a communication channel 358 and from current time portion 306 via a communication channel 360. Divide by 23 portion 310 receives information from number days lived portion 308 via a communication channel 362. Divide by 28 portion 312 receives information from number days lived portion 308 via communication channel 362. Divide by 33 portion 314 receives information from number days lived portion 308 via communication channel 362. Divide by 38 portion 316 receives information from number days lived portion 308 via communication channel 362. Remainder portion 318 receives information from divide by 23 portion 310 via a communication channel 370. Remainder portion 320 receives information from divide by 28 portion 312 via a communication channel 372. Remainder portion 322 receives information from divide by 33 portion 314 via a communication channel 374. Remainder portion 324 receives information from divide by 38 portion 316 via a communication channel 376. Multiply by 23 portion 23 receives information from remainder portion 318 via a communication channel 378. Multiply by 28 portion 328 receives information from remainder portion 320 via a communication channel 380. Multiply by 33 portion 330 receives information from remainder portion 322 via a communication channel 382. Multiply by 38 portion 332 receives information from remainder portion 324 via a communication channel 384. First date selection portion 334 receives information from multiply by 23 portion 23 via a communication channel 386. Second date selection portion 336 receives information from multiply by 28 portion 328 via a communication channel 387. Third date selection portion 338 receives information from multiply by 33 portion 33 via a communication channel 388. Fourth date selection portion 340 receives information from multiply by 38 portion 332 via a communication channel 389. Pink/peach portion 354, red/orange portion 342 and magenta portion 350 receive information from first date selection portion 334 via a communication channel 391. Turquoise/teal portion 352 and yellow/green portion 344 receive information from second date selection portion 336 via a communication channel 392. Turquoise/teal portion 352 and blue/light blue portion 346 receive information from third date selection portion 338 via a communication channel 393. White/violet portion 348, magenta portion 350 and pink/peach portion 354 receive information from fourth date selection portion 340 via a communication channel 394. Birth date portion 302 performs processing associated with a person's date of birth. As a non-limiting example, birth date may be received via a dialogue box. Current date portion 304 performs processing associated with current date. Current time portion 306 performs processing associated with current time. Number days lived portion 308 performs processing associated with number of days lived. Divide by 23 portion 310 performs a divide by 23 operation. Divide by 28 portion 312 performs a divide by 28 operation. Divide by 33 performs a divide by 33 operation. Divide by 38 performs a divide by 38 operation. Remainder portion 318, 320, 322 and 324 perform a remainder operation. Multiply by 23 portion 23 performs a multiply by 23 operation. Multiply by 28 performs a multiply by 28 operation. Multiply by 33 performs a multiply by 33 operation. Multiply by 38 performs a multiply by 38 operation. First date selection portion 334 performs a selection for a time period between 11.5 and 23 days. Second date selection portion 336 performs a selection for a time period between 14 and 28 days. Third date selection portion 338 performs a selection for a time period between 16.5 and 33 days. Fourth date selection portion 340 performs a selection for a time period between 19 and 38 days. Red/orange portion 342 present an amount of red/orange when selected and a zero amount of red/orange when not selected. Yellow/green portion 344 present an amount of yellow/green when selected and a zero amount of yellow/green when not selected. Blue/light blue portion 346 present an amount of blue/light blue when selected and a zero amount of blue/light blue when not selected. White/violet portion 348 present an amount of white/violet when selected and a zero amount of white/violet when not selected. Magenta portion 350 may present an amount of magenta based upon the average of the received inputs. Turquoise/teal portion 352 may present an amount of turquoise/teal based upon the average of the received inputs. Pink/peach portion 354 may present an amount of pink/peach based upon the average of the received inputs.

As a non-limiting example, red/orange portion 342 corresponds to color portion 208 (FIGS. 2A-B) where the amount of the color red associated with red color bar 216 (FIGS. 2A-B) and the amount of the color orange associated with orange color bar 218 (FIGS. 2A-B) are presented based upon the processing performed by red/orange portion 342. Furthermore, yellow/green portion 344 corresponds to color portion 210 (FIGS. 2A-B) where the amount of the color yellow associated with yellow color bar 220 (FIGS. 2A-B) and the amount of the color green associated with green color bar 222 (FIGS. 2A-B) are presented are based upon the processing performed by yellow/green portion 344. Furthermore, blue/light blue portion 346 corresponds to color portion 212 (FIGS. 2A-B) where the amount of the color blue associated with blue color bar 224 (FIGS. 2A-B) and the amount of the color light blue associated with light blue color bar 226 (FIGS. 2A-B) are presented based upon the processing performed by blue/light blue portion 346. Furthermore, white/violet portion 348 corresponds to color portion 214 (FIGS. 2A-B) where the amount of the color white associated with white color bar 228 (FIGS. 2A-B) and the amount of the color violet associated with violet color bar 230 (FIGS. 2A-B) are presented based upon the processing performed by white/violet portion 348. Furthermore, magenta portion 350 corresponds to magenta color bar 236 (FIG. 2B) where the amount of the color magenta associated with magenta color bar 236 (FIG. 2B) is presented based upon the processing performed by magenta portion 350. Furthermore, turquoise/teal portion 352 corresponds to color portion 234 (FIG. 2B) where the amount of the color turquoise associated with turquoise color bar 242 (FIG. 2B) and the amount of teal associated with teal color bar 244 (FIG. 2B) are presented based upon the processing performed by turquoise/teal portion 352. Furthermore, pink/peach portion 354 corresponds to color portion 232 (FIG. 2B) where the amount of the color pink associated with pink color bar 238 (FIG. 2B) and the amount of the color peach associated with peach color bar 240 (FIG. 2B) are presented based upon the processing performed by pink/peach portion 354.

In a non-limiting example, suppose a person has lived for 40 years and 89 days or a total of 14,699 days. Due to leap year, a year is noted as being 365.25 days. The number 14,699 is now divided by the four cycles of 23, 28, 33 and 38, respectively. Dividing 14,699 by 23 equals 639.0869565217. Dividing 14,699 by 28 equals 524.96428571. Dividing 14,699 by 33 equals 445.42424242. Dividing 14,699 by 38 equals 386.81578947. The respective remainders are then multiplied by 23, 28, 33, and 38, respectively. Multiplying 0.0869565217 by 23 equals 1.9999999991 which represents approximately 2 days into the 23 day cycle, therefore red and orange are not selected, as red and orange are selected on day 11.5 through day 23. Multiplying 0.96428571 by 28 equals 26.99999988 or approximately 27 days in the 28 day cycle, therefore yellow and green are selected, as yellow and green are selected on day 14 through day 28. Multiplying 0.42424242 by 33 equals 13.9999 or 14 days into a 33 day cycle, therefore the colors blue and light blue are not selected as they are selected from day 16.5 through day 33. Multiplying 0.81578947 by 38 equals 30.99999986 or approximately 31 days into a cycle of 38, therefore violet and white are selected, as violet and white are selected from 19 days to 38 days. In this example, a generic calculator was used and the least significant digits may not be exact. One of ordinary skill will readily recognize that the results of the multiplying functions should be rounded to integers. In some embodiments of the present invention, instead of using the decimal portion of the division results in the multiplying steps, the integer portion is used and an additional step of subtracting the multiplication results from the total days yields the integer remainders or days into the cycles. In some embodiments of the present invention, a Euclidean division process is used producing an integer quotient and an integer remainder. This may replace the processes of dividing and multiplying to obtain the integer remainders or days into the cycles. One of ordinary skill will readily recognize that other mathematical operations may be used to achieve the same results and are included within the scope of the present invention.

When red and orange are selected and white is also selected, then the colors pink and peach are selected. For this example, since red and orange are not selected, then pink and peach are also not selected. When green is selected and blue and light blue are also selected, then turquoise and teal are also selected. For this example, since blue and light blue are not selected, then turquoise and teal are not selected. When violet is selected and red is selected, then magenta is selected. For this example, since red is not selected, then magenta is also not selected. As a non-limiting example, a user may use the presented/non-presented colors in order to determine what color of clothes to wear. Furthermore, the user may select to wears clothes matching the selected colors or some of the selected colors and may choose to not wear cloths matching the non-selected colors.

Color system 300 enables a user to determine in advance selected colors. For example, a user may determine that the color red is selected a year in advance of the current date.

Color system 300 may enable a user to reduce the amount of time needed for selection of clothing to wear, as color system 300 may be used to reduce the potential choices.

Color system 300 may enable a user improve their personal presentation via selection of appropriate colors.

In operation, birth date of user is received via birth date portion 302. Number days lived portion receives user's birth date information from birth date portion 302, receives the current date from current date portion 304 and receives the current time from current time portion 306. Number days lived portion 308 processes the received birth date, current date and current time information in order to generate the number of days lived by user. As a non-limiting example, the number of days lived by user may be in decimal format. Divide by 23 portion 310, divide by 28 portion 312, divide by 33 portion 314 and divide by 38 portion 316 receive number of days lived information from number days lived portion 308 and perform a divide by 23, a divide by 28, a divide by 33 and a divide by 38 operation, respectively.

In further operation, remainder portion 318 receives the number of days lived divided by 23 from divide by 23 portion 310 and performs processing in order to select the remainder portion of the received information. Remainder portion 320 receives the number of days lived divided by 28 from divide by 28 portion 312 and performs processing in order to select the remainder portion of the received information. Remainder portion 322 receives the number of days lived divided by 33 from divide by 33 portion 314 and performs processing in order to select the remainder portion of the received information. Remainder portion 324 receives the number of days lived divided by 38 from divide by 38 portion 316 and performs processing in order to select the remainder portion of the received information.

In continuing operation, multiply by 23 portion 326 receives remainder information from remainder portion 318 and performs processing in order to multiply the received information by 23. Multiply by 28 portion 328 receives remainder information from remainder portion 320 and performs processing in order to multiply the received information by 28. Multiply by 33 portion 330 receives remainder information from remainder portion 322 and performs processing in order to multiply the received information by 33. Multiply by 38 portion 332 receives remainder information from remainder portion 324 and performs processing in order to multiply the received information by 38.

In further operation, first date selection portion 334 receives divided/remaindered/multiplied information from multiply by 23 portion 326 and detects information with a value greater than or equal to 11.5 days and less than or equal to 23 days. Second date selection portion 336 receives divided/remaindered/multiplied information from multiply by 28 portion 328 and detects information with a value greater than or equal to 14 days and less than or equal to 28 days. Third date selection portion 338 receives divided/remaindered/multiplied information from multiply by 33 portion 330 and detects information with a value greater than or equal to 16.5 days and less than or equal to 33 days. Fourth date selection portion 340 receives divided/remaindered/multiplied information from multiply by 38 portion 332 and detects information with a value greater than or equal to 19 days and less than or equal to 38 days.

In continuing operation, red/orange portion 342 receives detected information from first date selection portion 334 and presents red/orange as selected for a number of days greater than or equal to 11.5 and less than or equal to 23 and presents the colors red and orange as not selected otherwise. Yellow/green portion 344 receives detected information from second date selection portion 336 and presents the colors yellow and green as selected for a number of days greater than 14 and less than or equal to 28 and presents the colors yellow and green as not selected otherwise. Blue/light blue portion 346 receives detected information from third date selection portion 338 and presents the colors blue and light blue as selected for a number of days greater than 16.5 and less than or equal to 33 and presents the colors blue and light blue as not selected otherwise. White/violet portion 348 receives detected information from fourth date selection portion 340 and presents the colors white and violet as selected for a number of days greater than or equal to 19 and less than or equal to 38 and presents the colors white and violet as not selected otherwise. Magenta portion 350 receives detected information from first date selection portion 334 and from fourth date selection portion 340. Furthermore, magenta portion 350 presents the color magenta as selected when detecting a value greater than or equal to 11.5 days and less than or equal to 23 days from first date selection portion 334 and when detecting a value greater than or equal to 19 days and less than or equal to 38 days from fourth date selection portion 340, otherwise, the color magenta is presented as not selected. Turquoise/teal portion 352 receives detected information from second date selection portion 336 and from third date selection portion 338. Furthermore, turquoise/teal portion 352 presents the color teal and the color turquoise as selected when detecting a value greater than or equal to 14 days and less than or equal to 28 days from second date selection portion 336 and when detecting a value greater than or equal to 16.5 days and less than or equal to 33 days from third date selection portion 338, otherwise the color teal and the color turquoise are presented as not selected. Pink/peach portion 354 receives detected information from first date selection portion 334 and from fourth date selection portion 340. Furthermore, pink/peach portion 354 presents the color pink and the color peach as selected when detecting a value greater than or equal to 11.5 days and less than or equal to 23 days from first date selection portion 334 and when detecting a value greater than or equal to 19 and less than or equal to 38 days from fourth date selection portion 340, otherwise the color pink and the color peach are presented as not selected.

In alternate embodiments of the color system, a computing system uses a modulo operation to find the integer remainder of division of one integer number by another integer number. Given two positive numbers, a (the dividend) and n (the divisor), a modulo n (abbreviated as a mod n) is the integer remainder of the Euclidean division of a by n. This modulo operation replaces the processes of dividing, extracting the decimal remainder and multiplying to obtain the integer remainder of days into the cycle.

FIG. 3 is an example color system where colors are presented as selected or not selected based upon cyclical day information.

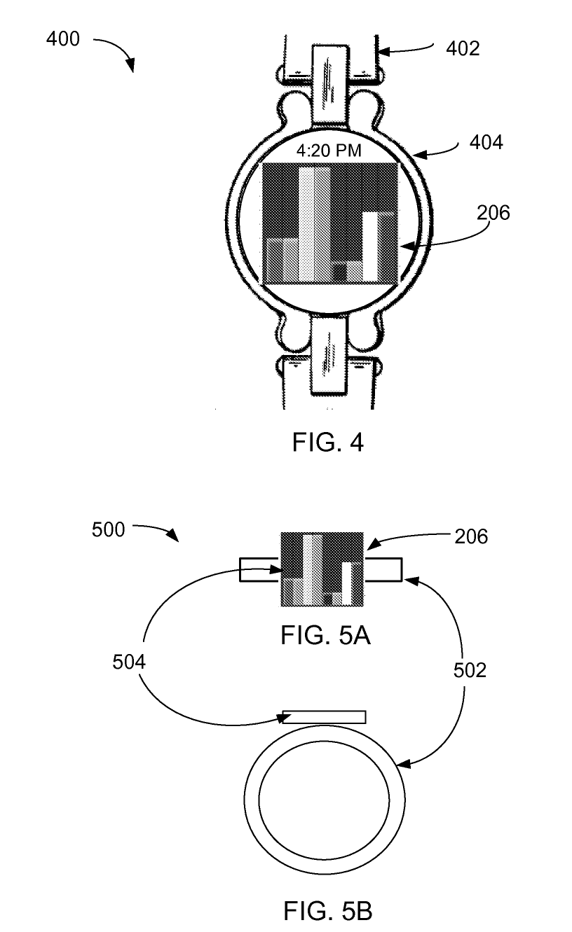

FIG. 4 is an example color system, in accordance with an alternative embodiment of the present invention.

A color system 400 includes a watch 402 and a wrist band 404. Watch 402 presents current time information as well as color information. Wrist band 404 attaches watch 402 to a wrist. In some embodiments, this watch may also be shaped as a half globe and display and light up and shine/glow the colors presented as selected or not selected based upon cyclical day information. Watch 402 includes color chart 206 as described with reference to FIG. 2.

FIG. 4 is an example color system configured as a watch.

FIGS. 5A-B illustrate an example color system, in accordance with an alternative embodiment of the present invention.

FIG. 5A presents a top view of a color system 500 and FIG. 5B presents a side view of color system 500.

Color system 500 includes a ring portion 502 and a presentation portion 504. Ring portion 502 may be placed on a finger. Presentation portion 504 presents color information.

Presentation portion 504 includes color chart 206 as described with reference to FIG. 2. FIGS. 5A-B illustrate an example color system configured as a ring. In some embodiments, presentation portion 504 may also be shaped as a half globe and display and light up and shine/glow the colors presented as selected or not selected based upon cyclical day information.

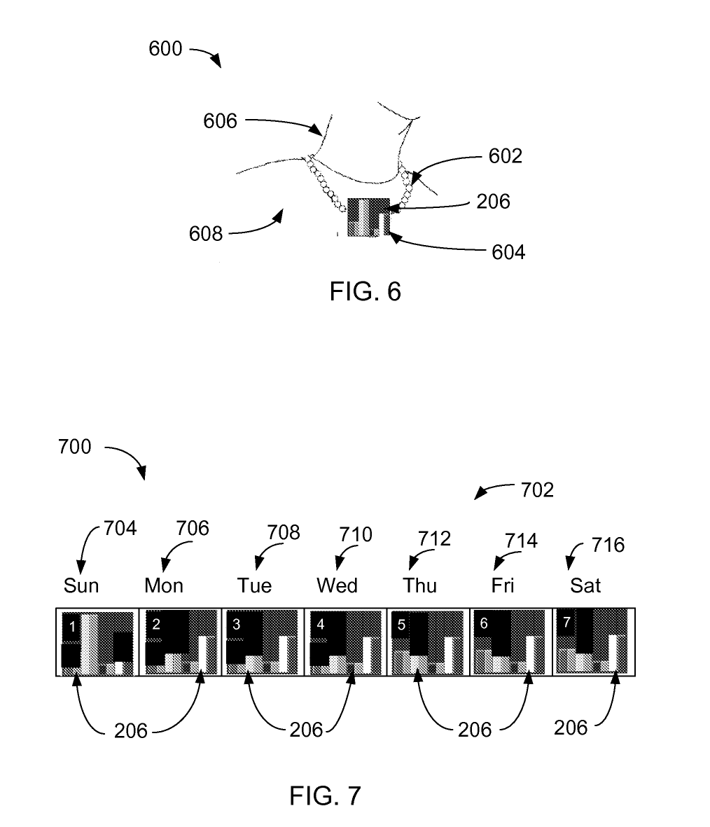

FIG. 6 is an example color system, in accordance with an alternative embodiment of the present invention.

A color system 600 includes a necklace portion 602 and a presentation portion 604.

Necklace portion 602 attaches to presentation portion 604 and configures color system 600 about a human neck 606 and adjacent to the upper portion of a human torso 608.

FIG. 6 is an example color system configured as a necklace. In some embodiments, presentation portion 604 may also be shaped as a half globe and display light up or glow the colors presented as selected or not selected based upon cyclical day information.

FIG. 7 is an example color system, in accordance with an alternative embodiment of the present invention.

A color system 700 includes a calendar 702 and a multiplicity of color chart 206 as described with reference to FIG. 2.

Calendar 702 includes a day 704 noted as Sunday, a day 706 noted as Monday, a day 708 noted as Tuesday, a day 710 noted as Wednesday, a day 712 noted as Thursday, a day 714 noted as Friday and a day 716 noted as Saturday. Days 704, 706, 708, 710, 712, 714 and 716 include respective color chart 206. Day 704 illustrates yellow and green selected with white and violet as not selected. Days 706, 708, 710, 712, 714 and 716 illustrate white and violet as selected with yellow and green as not selected.

FIG. 7 is an example color system configured as calendar.

In another embodiment, color system may be configured as a lamp. An illumination means may be used to shine the colors. In a non-limiting example, illumination means may shine the colors upon a wall or a user. The different colors may be, but not limited to, derived by light shining through colored glass, plastic jells, prisms or crystals projecting this light upon a wall or a user.

In another alternate embodiment, a projector such as, but not limited to, a LCD projector may be used to present the colors.

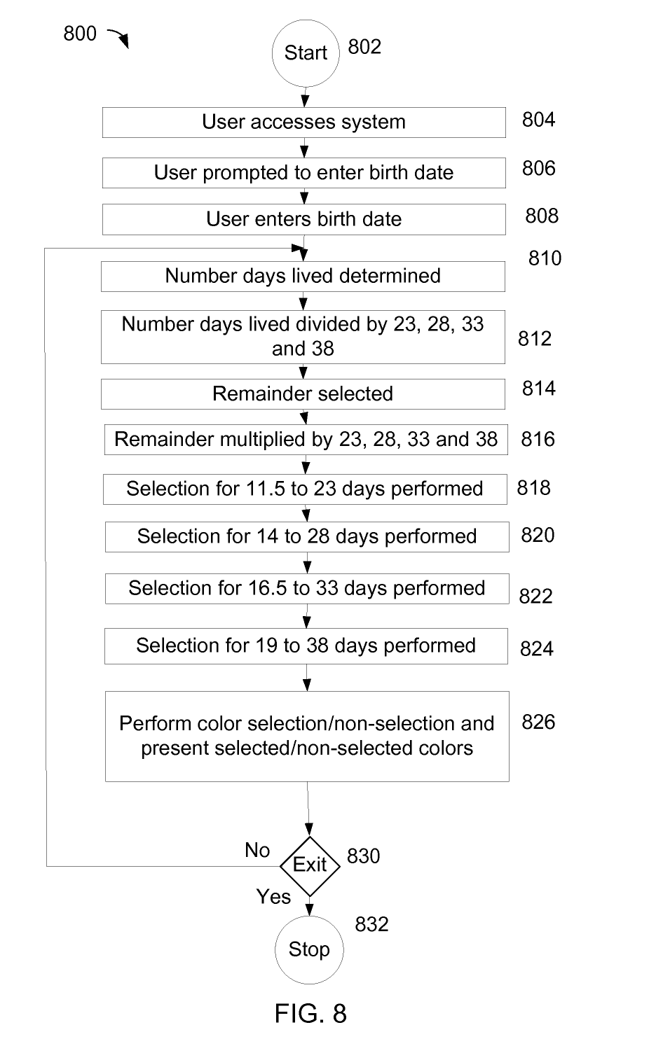

FIG. 8 illustrates an example method for the color system as described with reference to FIGS. 1-7, in accordance with an embodiment of the present invention.

Referring to FIG. 8, a method 800 initiates in a step 802.

Then in a step 804, user accesses system.

User enters information for accessing system and is presented with initial page for viewing (e.g. presentation 100 (FIG. 1)). Non-limiting examples of user information include name, user identification and password. Name may be presented as described with reference to information portion 112 (FIG. 1).

Referring back to FIG. 8, then in a step 806 user is prompted to enter birth date.

If system does not have birth date information, user is presented with a prompt to enter birth date information.

Referring to FIG. 8, then in a step 808 user enters birth day information. If system does not have birth date information, user enters birth date information with birth date information received by birth date portion 302 (FIG. 3). System may present the entered birth date as described with reference to information portion 112 (FIG. 1). Referring back to FIG. 8, then in a step 810 the number of days lived is determined. Number days lived portion 308 receives user's birth date information from birth date portion 302 (FIG. 3), receives the current date from current date portion 304 (FIG. 3) and receives the current time from current time portion 306 (FIG. 3). Number days lived portion 308 (FIG. 3) processes the received birth date, current date and current time information in order to generate the number of days lived by user. As a non-limiting example, the number of days lived by user may be in decimal format.

Referring back to FIG. 8, then in a step 812 number days lived is divided by 23, 28, 33 and 38 to generate number of days lived divided by 23, 28, 33 and 38, respectively.

Divide by 23 portion 310 (FIG. 3), divide by 28 portion 312 (FIG. 3), divide by 33 portion 314 and divide by 38 portion 316 (FIG. 3) receive number of days lived information from number days lived portion 308 (FIG. 3) and perform a divide by 23, a divide by 28, a divide by 33 and a divide by 38 operation, respectively.

Referring back to FIG. 8, then in a step 814 remainder selected for number of days lived divided by 23, 28, 33 and 38 determined in step 812.

Remainder portion 318 (FIG. 3) receives the number of days lived divided by 23 from divide by 23 portion 310 (FIG. 3) and performs processing in order to select the remainder portion of the received information. Remainder portion 320 (FIG. 3) receives the number of days lived divided by 28 from divide by 28 portion 312 (FIG. 3) and performs processing in order to select the remainder portion of the received information. Remainder portion 322 (FIG. 3) receives the number of days lived divided by 33 from divide by 33 portion 314 (FIG. 3) and performs processing in order to select the remainder portion of the received information. Remainder portion 324 (FIG. 3) receives the number of days lived divided by 38 from divide by 38 portion 316 (FIG. 3) and performs processing in order to select the remainder portion of the received information.

Referring back to FIG. 8, then in a step 816 remainder values determined in step 814 are multiplied by 23, 28, 33, 38 to generated a multiplied by 23, 28, 33 and 38 value, respectively.

Multiply by 23 portion 326 (FIG. 3) receives remainder information from remainder portion 318 (FIG. 3) and performs processing in order to multiply the received information by 23. Multiply by 28 portion 328 receives remainder information from remainder portion 320 (FIG. 3) and performs processing in order to multiply the received information by 28. Multiply by 33 portion 330 (FIG. 3) receives remainder information from remainder portion 322 (FIG. 3) and performs processing in order to multiply the received information by 33. Multiply by 38 portion 332 (FIG. 3) receives remainder information from remainder portion 324 (FIG. 3) and performs processing in order to multiply the received information by 38.

Referring back to FIG. 8, then in a step 818 selection for 11.5 to 23 days performed.

First date selection portion 334 (FIG. 3) receives divided/remaindered/multiplied information from multiply by 23 portion 326 (FIG. 3) and detects information with a value greater than or equal to 11.5 days and less than or equal to 23 days.

Referring back to FIG. 8, then in a step 820, selection for 14 to 28 days performed.

Second date selection portion 336 (FIG. 3) receives divided/remaindered/multiplied information from multiply by 28 portion 328 (FIG. 3) and detects information with a value greater than or equal to 14 days and less than or equal to 28 days.

Referring back to FIG. 8, then in a step 822, selection for 16.5 to 33 days performed.

Third date selection portion 338 (FIG. 3) receives divided/remaindered/multiplied information from multiply by 33 portion 330 (FIG. 3) and detects information with a value greater than or equal to 16.5 days and less than or equal to 33 days.

Referring back to FIG. 8, then in a step 824, selection for 19 to 38 days performed.

Fourth date selection portion 340 (FIG. 3) receives divided/remaindered/multiplied information from multiply by 38 portion 332 (FIG. 3) and detects information with a value greater than or equal to 19 days and less than or equal to 38 days.

Referring back to FIG. 8, then in a step 826 color preference/non-preference selection is performed and selected/non-selected colors are presented.

Red/orange portion 342 (FIG. 3) receives detected information from first date selection portion 334 (FIG. 3) and presents red/orange as selected for a number of days greater than or equal to 11.5 and less than or equal to 23 and presents the colors red and orange as not selected otherwise. Yellow/green portion 344 (FIG. 3) receives detected information from second date selection portion 336 (FIG. 3) and presents the colors yellow and green as selected for a number of days greater than 14 and less than or equal to 28 and presents the colors yellow and green as not selected otherwise. Blue/light blue portion 346 (FIG. 3) receives detected information from third date selection portion 338 (FIG. 3) and presents the colors blue and light blue as selected for a number of days greater than 16.5 and less than or equal to 33 and presents the colors blue and light blue as not selected otherwise. White/violet portion 348 (FIG. 3) receives detected information from fourth date selection portion 340 (FIG. 3) and presents the colors white and violet as selected for a number of days greater than or equal to 19 and less than or equal to 38 and presents the colors white and violet as not selected otherwise. Magenta portion 350 (FIG. 3) receives detected information from first date selection portion 334 (FIG. 3) and from fourth date selection portion 340 (FIG. 3). Furthermore, magenta portion 350 (FIG. 3) presents the color magenta as selected when detecting a value greater than or equal to 11.5 days and less than or equal to 23 days from first date selection portion 334 (FIG. 3) and when detecting a value greater than or equal to 19 days and less than or equal to 38 days from fourth date selection portion 340 (FIG. 3), otherwise, the color magenta is presented as not selected. Turquoise/teal portion 352 (FIG. 3) receives detected information from second date selection portion 336 (FIG. 3) and from third date selection portion 338 (FIG. 3). Furthermore, turquoise/teal portion 352 (FIG. 3) presents the color teal and the color turquoise as selected when detecting a value greater than or equal to 14 days and less than or equal to 28 days from second date selection portion 336 (FIG. 3) and when detecting a value greater than or equal to 16.5 days and less than or equal to 33 days from third date selection portion 338 (FIG. 3), otherwise the color teal and the color turquoise are presented as not selected. Pink/peach portion 354 (FIG. 3) receives detected information from first date selection portion 334 (FIG. 3) and from fourth date selection portion 340 (FIG. 3). Furthermore, pink/peach portion 354 (FIG. 3) presents the color pink and the color peach as selected when detecting a value greater than or equal to 11.5 days and less than or equal to 23 days from first date selection portion 334 (FIG. 3) and when detecting a value greater than or equal to 19 and less than or equal to 38 days from fourth date selection portion 340 (FIG. 3), otherwise the color pink and the color peach are presented as not selected.

Referring back to FIG. 8, a determination for exiting method 800 is performed in a step 830.

Referring to FIG. 8, for a determination of not exiting method 800 in step 830, execution of method 800 transitions to step 810.

Referring to FIG. 8, for a determination of exiting method 800 in step 830, then in a step 832 execution of method 800 terminates.

FIG. 8 illustrates an example method for the color system as described with reference to FIGS. 1-7 where a user accesses color system, user is prompted to enter birth date, user enters birth date, number of days lived is determined, number of days lived is divided by 23, 28, 33 and 38, four selections for divided values is performed, color preference/non-preference is performed and selected/non-selected colors are presented.

As a non-limiting example, selected colors and non-selected colors may be presented as described with reference to color presentation 200 (FIG. 2A), color presentation 201 (FIG. 2B), color system 400 (FIG. 4), color system 500 (FIGS. 5A-B), color system 600 (FIG. 6) and/or color system 700 (FIG. 7).

In a non-limiting example, suppose a person has lived for 40 years and 89 days or a total of 14,699 days. Due to leap year, a year is noted as being 365.25 days. The number 14,699 is now divided by the four cycles of 23, 28, 33 and 38, respectively. Dividing 14,699 by 23 equals 639.0869565217. Dividing 14,699 by 28 equals 524.96428571. Dividing 14,699 by 33 equals 445.42424242. Dividing 14,699 by 38 equals 386.81578947. The respective remainders are then multiplied by 23, 28, 33, and 38, respectively. Multiplying 0.0869565217 by 23 equals 1.9999999991 which represents approximately 2 days into the 23 day cycle, therefore red and orange are not selected, as red and orange are selected on day 11.5 through day 23. Multiplying 0.96428571 by 28 equals 26.99999988 or approximately 27 days in the 28 day cycle, therefore yellow and green are selected, as yellow and green are selected on day 14 through day 28. Multiplying 0.42424242 by 33 equals 13.9999 or 14 days into a 33 day cycle, therefore the colors blue and light blue are not selected as they are selected from day 16.5 through day 33. Multiplying 0.81578947 by 38 equals 30.99999986 or approximately 31 days into a cycle of 38, therefore violet and white are selected, as violet and white are selected from 19 days to 38 days. In this example, a generic calculator was used and the least significant digits may not be exact. One of ordinary skill will readily recognize that the results of the multiplying functions should be rounded to integers. In some embodiments of the present invention, a Euclidean division process is used producing an integer quotient and an integer remainder. This replaces the processes of dividing and multiplying to obtain the integer remainders or days into the cycles.

In alternate embodiments of methods for the color system, a computing system uses a modulo operation to find the integer remainder of division of one integer number by another integer number. Given two positive numbers, a (the dividend) and n (the divisor), a modulo n (abbreviated as a mod n) is the integer remainder of the Euclidean division of a by n. This modulo operation may replace the processes of dividing, extracting the decimal remainder and multiplying (steps 812, 814 and 816) to obtain the integer remainder of days into the cycle.

When red and orange are selected and white is also selected, then the colors pink and peach are selected. For this example, since red and orange are not selected, then pink and peach are also not selected. When green is selected and blue and light blue are also selected, then turquoise and teal are also selected. For this example, since blue and light blue are not selected, then turquoise and teal are not selected. When violet is selected and red is selected, then magenta is selected. For this example, since red is not selected, then magenta is also not selected. As a non-limiting example, a user may use the presented/non-presented colors in order to determine what color of clothes to wear. Furthermore, the user may select to wears clothes matching the selected colors or some of the selected colors and may select to not wear cloths matching the non-selected colors.

A color system has been described which provides means and methods for selecting appropriate colors and not selecting appropriate colors. Color system uses biorhythm information in order to extract certain information which is combined with an algorithm for producing a presentation of colors representing selected colors and not selected colors. As a non-limiting example, color system may be used for selecting the appropriate color of clothes to wear based upon a certain day. Non-limiting examples of applications for color system include clothes, makeup and signs. The color system performs color selection based upon four different cycles with respective cycles of 23, 28, 33 and 38 days.

In an alternative embodiment, color system does not operate for the purpose of matching colors. Furthermore, color system does not operate for identifying colors. Furthermore, color system does not operate for determining clothing size or seasonal information associated with selection of clothing.

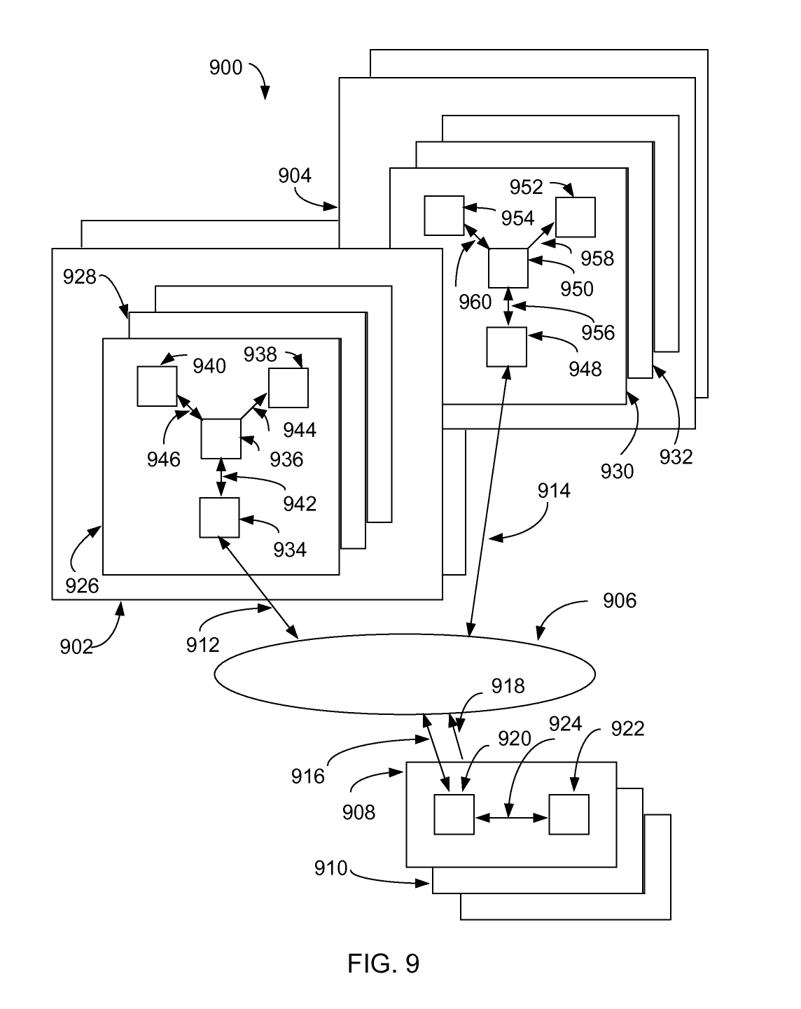

FIG. 9 illustrates a block diagram depicting a conventional client/server communication system.

A communication system 900 includes a multiplicity of networked regions with a sampling of regions denoted as a network region 902 and a network region 904, a global network 906 and a multiplicity of servers with a sampling of servers denoted as a server device 908 and a server device 910.

Network region 902 and network region 904 may operate to represent a network contained within a geographical area or region. Non-limiting examples of representations for the geographical areas for the networked regions may include postal zip codes, telephone area codes, states, counties, cities and countries. Elements within network region 902 and 904 may operate to communicate with external elements within other networked regions or within elements contained within the same network region. In some implementations, global network 906 may operate as the Internet. It will be understood by those skilled in the art that communication system 900 may take many different forms. Non-limiting examples of forms for communication system 900 include local area networks (LANs), wide area networks (WANs), wired telephone networks, cellular telephone networks or any other network supporting data communication between respective entities via hardwired or wireless communication networks. Global network 906 may operate to transfer information between the various networked elements.

Server device 908 and server device 910 may operate to execute software instructions, store information, support database operations and communicate with other networked elements. Non-limiting examples of software and scripting languages which may be executed on server device 908 and server device 910 include C, C++, C# and Java.

Network region 902 may operate to communicate bi-directionally with global network 906 via a communication channel 912. Network region 904 may operate to communicate bi-directionally with global network 906 via a communication channel 914. Server device 908 may operate to communicate bi-directionally with global network 906 via a communication channel 916. Server device 910 may operate to communicate bi-directionally with global network 906 via a communication channel 918. Network region 902 and 904, global network 906 and server devices 908 and 910 may operate to communicate bi-directionally and also communicate bi-directionally with other networked device located within communication system 900.

Server device 908 includes a networking device 920 and a server 922. Networking device 920 may operate to communicate bi-directionally with global network 906 via communication channel 916 and with server 922 via a communication channel 924. Server 922 may operate to execute software instructions and store information. Network region 902 includes a multiplicity of clients with a sampling denoted as a client 926 and a client 928. Client 926 includes a networking device 934, a processor 936, a GUI 938 and an interface device 940. Non-limiting examples of devices for GUI 938 include monitors, televisions, cellular telephones, smartphones, tablets and PDAs (Personal Digital Assistants). Non-limiting examples of interface device 940 include pointing device, mouse, trackball, scanner and printer. Networking device 934 may communicate bi-directionally with global network 906 via communication channel 912 and with processor 936 via a communication channel 942. GUI 938 may receive information from processor 936 via a communication channel 944 for presentation to a user for viewing. Interface device 940 may operate to send control information to processor 936 and to receive information from processor 936 via a communication channel 946. Network region 904 includes a multiplicity of clients with a sampling denoted as a client 930 and a client 932. Client 930 includes a networking device 948, a processor 950, a GUI 952 and an interface device 954. Non-limiting examples of devices for GUI 938 include monitors, televisions, cellular telephones, smartphones, tablets and PDAs (Personal Digital Assistants). Non-limiting examples of interface device 940 include pointing devices, mousse, trackballs, scanners and printers. Networking device 948 may communicate bi-directionally with global network 906 via communication channel 914 and with processor 950 via a communication channel 956. GUI 952 may receive information from processor 950 via a communication channel 958 for presentation to a user for viewing. Interface device 954 may operate to send control information to processor 950 and to receive information from processor 950 via a communication channel 960.

For example, consider the case where a user interfacing with client 926 may want to execute a networked application. A user may enter the IP (Internet Protocol) address for the networked application using interface device 940. The IP address information may be communicated to processor 936 via communication channel 946. Processor 936 may then communicate the IP address information to networking device 934 via communication channel 942. Networking device 934 may then communicate the IP address information to global network 906 via communication channel 912. Global network 906 may then communicate the IP address information to networking device 920 of server device 908 via communication channel 916. Networking device 920 may then communicate the IP address information to server 922 via communication channel 924. Server 922 may receive the IP address information and after processing the IP address information may communicate return information to networking device 920 via communication channel 924. Networking device 920 may communicate the return information to global network 906 via communication channel 916. Global network 906 may communicate the return information to networking device 934 via communication channel 912. Networking device 934 may communicate the return information to processor 936 via communication channel 942. Processor 936 may communicate the return information to GUI 938 via communication channel 944. User may then view the return information on GUI 938.

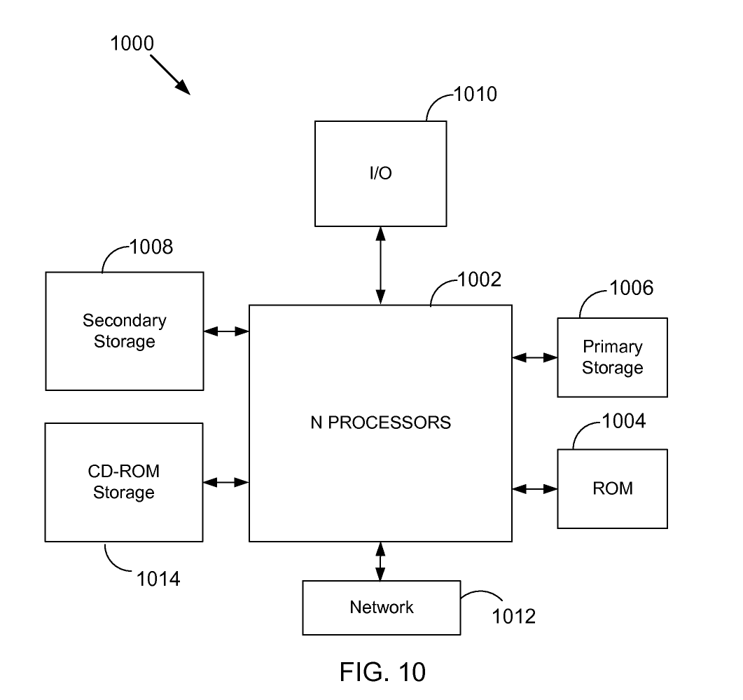

FIG. 10 illustrates a typical computer system that, when appropriately configured or designed, may serve as a computer system 1000 for which the present invention may be embodied.

Computer system 1000 includes a quantity of processors 1002 (also referred to as central processing units, or CPUs) that may be coupled to storage devices including a primary storage 1006 (typically a random access memory, or RAM), a primary storage 1004 (typically a read-only memory, or ROM). CPU 1002 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 1004 acts to transfer data and instructions uni-directionally to the CPU and primary storage 1006 typically may be used to transfer data and instructions in a bi-directional manner. The primary storage devices discussed previously may include any suitable computer-readable media such as those described above. A mass storage device 1008 may also be coupled bi-directionally to CPU 1002 and provides additional data storage capacity and may include any of the computer-readable media described above. Mass storage device 1008 may be used to store programs, data and the like and typically may be used as a secondary storage medium such as a hard disk. It will be appreciated that the information retained within mass storage device 1008, may, in appropriate cases, be incorporated in standard fashion as part of primary storage 1006 as virtual memory. A specific mass storage device such as a CD-ROM 1014 may also pass data uni-directionally to the CPU.

CPU 1002 may also be coupled to an interface 1010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to an external device such as a database or a computer or telecommunications or internet network using an external connection shown generally as a network 1012, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a color system according to the present invention will be apparent to those skilled in the art. The invention has been described above by way of illustration, and the specific embodiments disclosed are not intended to limit the invention to the particular forms disclosed. For example, the particular implementation of the presentations views may vary depending upon the particular type of computing device used. The computing devices described in the foregoing were directed to laptop and tablet computing devices implementations; however, similar techniques for smartphone implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
obtaining a birth date for a user;
determining a total number of days from said birth date to a at least a selected date selected by the user;
determining a first number of days into a first cycle of first days for said total number of days;
selecting a first pair of colors when said first number of days is into a a portion of said first cycle of days;
determining a second number of days into a second cycle of second days for said total number of days;
selecting a second pair of colors when said second number of days is into a portion of said second cycle of days;
determining a third number of days into a third cycle of third days for said total number of days;
selecting a third pair of colors when said third number of days is into a portion of said third cycle of days;
determining a fourth number of days into a fourth cycle of fourth days for said total number of days;
selecting a fourth pair of colors when said fourth number of days is into a portion of said fourth cycle of days; and
displaying said selected colors to the user.

2. The method as recited in claim 1, in which said first pair of colors comprises red and orange, said second pair of colors comprises yellow and green, said third pair of colors comprises blue and light blue, and said fourth pair of colors comprises white and violet.

3. The method as recited in claim 1, in which said first cycle of first days comprises 23 days, said second cycle of second days comprises 28 days, said third cycle of third days comprises 33 days, and said fourth cycle of fourth days comprises 38 days.

4. The method as recited in claim 1, in which said upper portion of said first cycle of days comprises a second half of said first cycle, said upper portion of said second cycle of days comprises a second half of said second cycle, said upper portion of said third cycle of days comprises a second half of said third cycle, and said upper portion of said fourth cycle of days comprises a second half of said fourth cycle.

5. The method as recited in claim 1, further comprising the steps of:
selecting a first additional pair of colors when said first pair of colors and said fourth pair of colors are selected;
selecting a second additional pair of colors when said second pair of colors and said third pair of colors are selected; and
selecting an third additional color when said fourth pair of colors and said first pair of colors are selected.

6. The method as recited in claim 5, in which said first additional pair of colors comprises pink and peach, said second additional pair of colors comprises turquoise and teal, and said third additional color comprises magenta.

7. The method as recited in claim 1, in which a plurality of selected dates are selected, the method is performed for each of said plurality of selected dates, and a plurality of separate displays are displayed to the user.

8. The method as recited in claim 1, in which at least said selected colors are displayed as colored bars or any other graphic form.

9. The method as recited in claim 1, in which said selected colors are displayed in a portion of a jewelry article.

10. A system comprising:
an application unit being configured to be operable for obtaining a birth date for a user;
a processing unit in communication with said application unit and being configured to be operable for processing instructions for: determining a total number of days from said birth date to a at least a selected date selected by the user; determining a first portion into a first cycle and then determining a second portion of the first cycle for said total number of days; selecting a first pair of colors for second portion of first cycle to be shown in a graph or graphic form: determining a first portion of a second cycle and determining a second portion of said second cycle; selecting a second pair of colors when said second number of days is into second portion of said second cycle of days; displaying said second pair of colors in a graph or graphic form; determining a first portion of a third cycle and determining a second portion of said third cycle; selecting a third pair of color to be displayed in a graphic or graphic form; determining a first portion of a fourth cycle and determining a second portion of said fourth cycle; selecting a fourth pair of colors when said second number of days is into second portion of said fourth cycle of days selecting a fourth pair of colors when number of days is into a second portion of said fourth cycle of days; and displaying said fourth pair of colors in a graphic or graphic form.
a display unit in communication with said processing unit and being configured to be operable for displaying said selected colors to the user.

11. The system as recited in claim 10, in which said first cycle pair of colors comprises red and orange, said second cycle pair of colors comprises yellow and green, said third cycle pair of colors comprises blue and light blue, said fourth cycle pair of colors comprises white and violet, said first cycle of first days comprises 23 days, said second cycle of second days comprises 28 days, said third cycle of third days comprises 33 days, said fourth cycle of fourth days comprises 38 days, said a portion of said first cycle of days comprises a second half of said first cycle, sportion of said second cycle of days comprises a second half of said second cycle, said portion of said third cycle of days comprises a second half of said third cycle, said portion of said fourth cycle of days comprises a second half of said fourth cycle, said processing unit being further configured to be operable for processing instructions for selecting a first additional pair of colors when said first pair of colors and said fourth pair of colors are selected, said first additional pair of colors comprises pink and peach;
selecting a second additional pair of colors when said second pair of colors and said third pair of colors are selected, said second additional pair of colors comprises turquoise and teal; and
selecting an third additional color when said fourth pair of colors and said first pair of colors are selected, said third additional color comprises magenta, and said display unit being further configured to be operable for displaying said selected colors as colored bars or a graphic form

12. A non-transitory computer-readable storage medium with an executable program stored thereon, wherein the program instructs a processor to perform the following steps:
obtaining a birth date for a user;
determining a total number of days from said birth date to a at least a selected date selected by the user;
determining a first number of days into a first cycle of first days for said total number of days;
selecting a first pair of colors when said first number of days is into a portion of said first cycle of days;
determining a second number of days into a second cycle of second days for said total number of days;
selecting a second pair of colors when said second number of days is into an upper portion of said second cycle of days;
determining a third number of days into a third cycle of third days for said total number of days;
selecting a third pair of colors when said third number of days is into a portion of said third cycle of days;
determining a fourth number of days into a fourth cycle of fourth days for said total number of days;
selecting a fourth pair of colors when said fourth number of days is into a portion of said fourth cycle of days; and
displaying said selected colors to the user.

13. The program instructing the processor as recited in claim 12, in which said first pair of colors comprises red and orange, said second pair of colors comprises yellow and green, said third pair of colors comprises blue and light blue, and said fourth pair of colors comprises white and violet.

14. The program instructing the processor as recited in claim 12, in which said first cycle of first days comprises 23 days, said second cycle of second days comprises 28 days, said third cycle of third days comprises 33 days, and said fourth cycle of fourth days comprises 38 days.

15. The program instructing the processor as recited in claim 12, in which said upper portion of said first cycle of days comprises a second half of said first cycle, said upper portion of said second cycle of days comprises a second half of said second cycle, said upper portion of said third cycle of days comprises a second half of said third cycle, and said upper portion of said fourth cycle of days comprises a second half of said fourth cycle.

16. The program instructing the processor as recited in claim 12, further comprising the steps of:
selecting a first additional pair of colors when said first pair of colors and said fourth pair of colors are selected;
selecting a second additional pair of colors when said second pair of colors and said third pair of colors are selected; and
selecting an third additional color when said fourth pair of colors and said first pair of colors are selected.

17. The program instructing the processor as recited in claim 16, in which said first additional pair of colors comprises pink and peach, said second additional pair of colors comprises turquoise and teal, and said third additional color comprises magenta.

18. The program instructing the processor as recited in claim 12, in which a plurality of selected dates are selected, the method is performed for each of said plurality of selected dates, and a plurality of separate displays are displayed to the user.

19. The program instructing the processor as recited in claim 12, in which at least said selected colors are displayed as colored bars.

20. The program instructing the processor as recited in claim 12, in which said selected colors are displayed in a portion of a jewelry article.
